(19) United States
(12) Patent Application Publication
(10) Pub. No.: US 2025/0390819 A1
(43) Pub. Date: Dec. 25, 2025

(54) AGENT SYSTEM

(71) Applicant: Nomura Research Institute, Ltd., Tokyo (JP)

(72) Inventors: Yoko Matsuzaki, Tokyo (JP); Yudai Nagama, Tokyo (JP); Hisato Masuda, Tokyo (JP); Hajime Tamura, Tokyo (JP); Shota Fukuda, Tokyo (JP); Hiroki Kawasaki, Tokyo (JP); Yuuta Matsumoto, Tokyo (JP); Kenta Uehara, Tokyo (JP)

(21) Appl. No.: 18/809,944

(22) Filed: Aug. 20, 2024

(30) Foreign Application Priority Data
Jun. 21, 2024 (JP) 2024-100361

(51) Int. Cl. G06Q 10/0631

(52) U.S. Cl. CPC G06Q 10/06316

(57) ABSTRACT

The dialogue unit 11 grasps a business instruction by a dialogue with a user 2 by the generative AI, and stores a content of the dialogue as a dialogue log in a short-term storage 16, the solution unit 12 creates a task list by decomposing the business instruction into tasks by the generative AI and passes an execution instruction of each task to the execution unit 13, the execution unit 13 executes a work on a corresponding data source 3 by the generative AI corresponding to the task related to the execution instruction, and passes an execution result to the solution unit 12, and the monitoring unit 14 refers to the dialogue log at any time, grasps a context of the dialogue by the generative AI, predicts a content to be dealt with next, stores the content as a summary in the short-term storage 16.

### BACKGROUND OF THE INVENTION

### 1. Technical Field

The present invention relates to a technology of using generative artificial intelligence (AI), and particularly relates to a technology effective by being applied to an agent system that realizes agent-type AI.

### 2. Description of the Related Art

With the progress of IT technology, a large amount of information that exceeds human capacity for determination is flying around in the site of various operations, and a large number of business tasks are performed in parallel. As an application for assisting such a work situation with a high cognitive load, utilization of agent-type AI using generative AI and large language models (LLM) (hereinafter, may be collectively referred to as “generative AI”) including ChatGPT (registered trademark) is being explored. The agent-type AI here indicates AI that autonomously sets a goal to be achieved in accordance with a human instruction and autonomously executes necessary work toward the goal. Whether such agent-type AI can be realized using generative AI has been studied. However, the existing agent-type AI has various problems when utilized at an actual business site, and has not yet achieved drastic business transformation.

As a technology related to the agent-type AI, for example, JP 2018-81444 A (Patent Literature 1) discloses that a plurality of dialogue agent units for providing various services are provided for each service, and each of the dialogue agent unit is specialized in each service to provide a highly specialized service, while in a case where each dialogue agent is unable to respond by itself, a conversational sentence is transferred to another dialogue agent, thereby guiding a user to a dialogue agent that can make a more appropriate response.

### CITATION LIST

### Patent Literature

Patent Literature 1: JP 2018-81444 A

### SUMMARY OF THE INVENTION

### Technical Problem

According to the related art as described in JP 2018-81444 A, a plurality of highly specialized AI specialized for respective services are provided to cause AI capable of response to respond according to a problem, whereby it is possible to respond to various types of business or tasks, and it is possible to reduce installation and operation costs as compared with constructing a universal agent system.

However, in the agent system as in the related art, for example, it is difficult to realize agent-type AI that enables comprehensive and flexible response such as deciphering the orientation of the user from natural exchange with the user, autonomously constructing necessary tasks, and executing each task without requiring detailed instructions from the user.

In the regard, an object of the present invention is to provide an agent system that understands a business background and a business situation of a user in an agent-type AI by utilizing generative AI, and autonomously decomposes an abstract instruction into a specific task and executes the task.

The above-described and other objects and novel features of the present invention will be clarified by the description herein and the attached drawings.

### Solution to Problem

The outline of a representative one of the inventions disclosed in the present application will be briefly described as follows.

An agent system that is a representative embodiment of the present invention is an agent system that grasps a business problem from a dialogue with a user and executes a task related to the business instruction, and includes a dialogue unit, a solution unit, an execution unit, and a monitoring unit, each of which is capable of individually using generative AI.

Then, the dialogue unit grasps the business instruction by the dialogue with the user by the generative AI, and stores a content of the dialogue with the user as a dialogue log in a short-term storage unit, the solution unit creates a task list by decomposing the business instruction grasped by the dialogue unit into tasks by the generative AI, passes an execution instruction of each task to the execution unit, and presents an execution result by the execution unit to the user via the dialogue unit, the execution unit executes a work by using a corresponding data source by the generative AI corresponding to the task related to the execution instruction passed from the solution unit and passes an execution result to the solution unit, and the monitoring unit refers to the dialogue log at any time, extracts information regarding a predetermined matter set in advance, grasps a context of the dialogue by the generative AI, predicts a content to be dealt with next, stores the content as a summary in a short-term storage unit, and allows the dialogue unit, the solution unit, and the execution unit to refer to the content at any time.

### Advantageous Effects of Invention

The advantageous effect of the representative one of the inventions disclosed in the present application will be briefly described as follows.

That is, according to the representative embodiment of the present invention, in an agent-type AI utilizing the generative AI, it is possible to realize an agent system that understands a business background and a business situation of a user, and autonomously decomposes an abstract instruction into a specific task and executes the task.

### BRIEF DESCRIPTION OF THE DRAWINGS

FIG. 1 is a diagram illustrating an outline of a configuration example of an agent system that is one embodiment of the present invention;

FIG. 2 is a diagram illustrating an outline of an example of an architecture of the agent system in one embodiment of the present invention;

FIG. 3 is a diagram illustrating an outline of a solution example of [Problem 1] by a “mechanism 1” in one embodiment of the present invention;

FIG. 4 is a diagram illustrating an outline of a solution example of [Problem 2] by a “mechanism 2” in one embodiment of the present invention;

FIG. 5 is a diagram illustrating an outline of a solution example of [Problem 3] by a “mechanism 3” in one embodiment of the present invention;

FIG. 6 is a diagram illustrating an outline of a solution example of [Problem 4] by a “mechanism 4” in one embodiment of the present invention;

FIG. 7 is a diagram illustrating an outline of an example of a processing flow in one embodiment of the present invention;

FIG. 8 is a diagram illustrating an outline of an example of a processing flow in one embodiment of the present invention;

FIG. 9 is a diagram illustrating an outline of an example of a processing flow in one embodiment of the present invention;

FIG. 10 is a diagram illustrating an outline of an example of a processing flow in one embodiment of the present invention;

FIG. 11 is a diagram illustrating an outline of an example of a processing flow in one embodiment of the present invention;

FIG. 12 is a diagram illustrating an outline of an example of a processing flow in one embodiment of the present invention;

FIG. 13 is a diagram illustrating an outline of an example of a processing flow in one embodiment of the present invention;

FIG. 14 is a diagram illustrating an outline of an example of a prompt of a dialogue unit that generates a response to a user in one embodiment of the present invention;

FIG. 15 is a diagram illustrating an outline of an example of a prompt of a solution unit that creates a task list in one embodiment of the present invention; and

FIG. 16 is a diagram illustrating an outline of an example of a prompt of a monitoring unit that summarizes a dialogue log in one embodiment of the present invention.

### DETAILED DESCRIPTION

An embodiment of the present invention will be described in detail below with reference to the drawings. In all the drawings for describing the embodiment, the same parts are in principle given the same reference numerals, and duplicated description thereof will be omitted. In contrast, in some cases, a part described with a reference sign in a certain drawing might be referred to with the same reference sign in the description of another drawing although not illustrated again.

### <Outline>

In generative AI that is currently generally available, for example, it is possible to execute various tasks (for example, information acquisition or information processing) according to an instruction in text and answer with text. In addition, attempts have been made to realize agent-type AI that autonomously responds using the generative AI.

On the other hand, in realizing the agent-type AI, there are the following problems that cannot be solved only by the existing generative AI technology.

### [Problem 1]

The agent-type AI using the existing generative AI can autonomously execute a task in response to an instruction of a user, but cannot control execution propriety and an execution situation of the task according to interactive dialogue by the user.

### [Problem 2]

The agent-type AI using the existing generative AI can store the latest dialogue content, but cannot accumulate, store, and refer to past conversation content for a long time. For this reason, it is not possible to refer to accumulation of past knowledge by accumulation of individual dialogues, such as past work content with the user, current progress situation, and prior knowledge necessary for work, and it is necessary for the user to give necessary background knowledge each time the dialogue is started. In such a situation, it is not possible to realize understanding of the business instruction according to the business background through the dialogue.

### [Problem 3]

The agent-type AI using the existing generative AI is designed with an individual task or a predetermined series of tasks as an execution target, and the user gives a specific and detailed instruction to execute the individual task matching the instruction or a specified series of tasks. At this time, the agent-type AI using the existing generative AI determines whether the individual instruction content of the user meets a specified task execution requirement, and determines execution content. Therefore, it is not possible to respond to the instruction content not specified in the execution requirement. Therefore, it is necessary for the user to give a specific and detailed instruction suitable for the execution requirement, which can be determined by the agent-type AI, and it is necessary to execute the instruction while considering what task determination criterion the agent-type AI has.

### [Problem 4]

The agent-type AI using the existing generative AI compares the instruction content of the user with the execution requirement, and determines execution of the task. However, this determination often deviates from a realistic determination. This is because the generative AI makes a determination based on similarity of the semantics of the text and cannot determine the feasibility of the task or does not recognize whether the instruction content is within a range that can be solved by itself (the same kind of problem is raised as a frame problem of AI).

In the agent system that is one embodiment of the present invention, a mechanism for solving each of the above-described problems is introduced as follows (details of each mechanism will be described later).

“Mechanism 1” Control of Agent by Interactive Dialogue (corresponding to [Problem 1])

“Mechanism 2” Long-Term Storage Maintenance (corresponding to [Problem 2])

“Mechanism 3” Autonomous Decomposition of Abstract and Complex Instruction (corresponding to [Problem 3])

“Mechanism 4” Response to Frame Problem (corresponding to [Problem 4])

Since it is not realistic to cover a mechanism for solving the problem of the existing generative AI or the agent-type AI using the generative AI with one agent (generative AI), in the present embodiment, a plurality of agents are provided to set are roles, and hierarchization is performed. That is, the whole is divided into two layers of a “task layer” for designing and executing a task and a “meta layer” for monitoring and storing the whole situation. Then, for the task layer, processing steps are divided into “problem extraction”, “task design”, and “task execution”, and agents in charge of the respective processes are arranged, so as to realize an agent-type AI capable of appropriately understanding the business problem of the user and executing the task while concretizing the task into individual specific tasks.

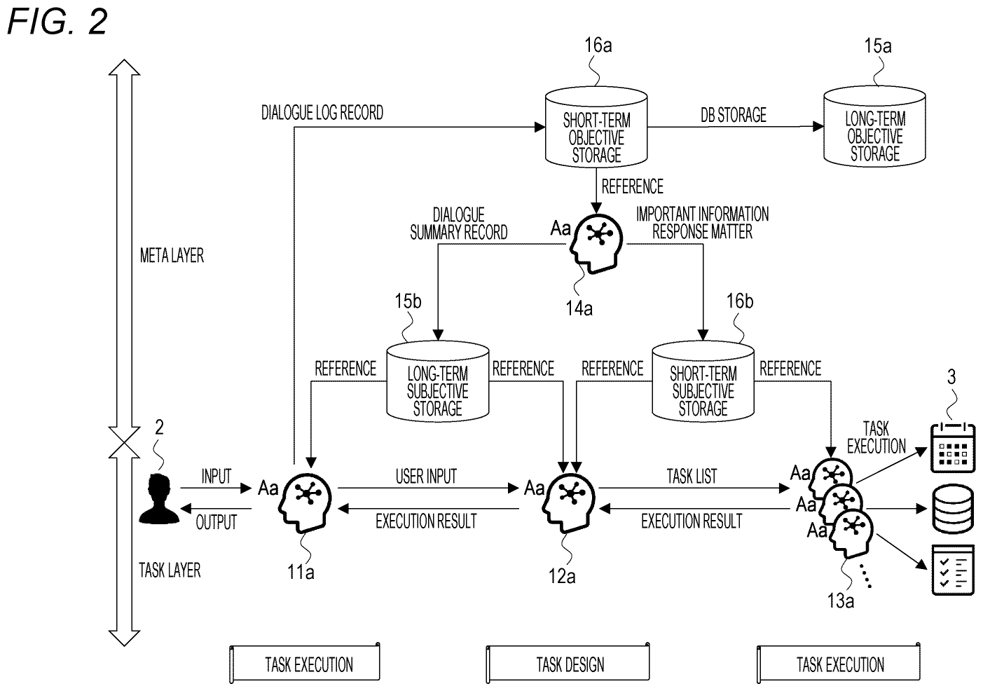

FIG. 2 is a diagram illustrating an outline of an architecture of the agent-type AI in one embodiment of the present invention. The example of FIG. 2 illustrates that the lower task layer is configured by each generative AI of dialogue AI (11a), solution AI (12a), and execution AI (13a), and the upper meta layer is configured by the generative AI of monitoring AI (14a). The task layer has a function of decomposing and executing complex tasks by role sharing of each generative AI and integrating results. On the other hand, the meta layer has a function of extracting, understanding, and accumulating design know-how of a business problem and a specific task necessary for solving the business problem from the dialogue with the user, and causing each generative AI of the task layer to appropriately refer to the design know-how.

The dialogue AI (11a) of the task layer has a function of performing a dialogue with a user 2 and responding in accordance with an implicit situation of the user 2. In addition, the solution AI (12a) has a function of receiving an input of an instruction of an abstract problem from the user 2, decomposing the input into specific tasks based on the accumulated business know-how, and integrating execution results of the tasks. That is, as the above-described “mechanism 3”, autonomous task design from an instruction with a high abstraction level is realized. In addition, the execution AI (13a) is configured by individual generative AI for each specialized business, and has a function of executing a task of acquiring and processing data from a corresponding data source 3 in response to an instruction input from the solution AI (12a), and responding to the solution AI (12a) with an execution result. At this time, an executable range is recognized by dialogue between the respective solution Als (12a), so that a response to the frame problem is realized with the above-described “mechanism 4”.

The monitoring AI (14a) of the meta layer has a function of monitoring the context from the dialogue content with the user to understand the context, and causing each generative AI of the task layer to operate according to the context. At this time, in a case where the dialogue content is insufficient in understanding the context, an interactive inquiry is made to the user 2 via the dialogue AI (11a) to supplement the information, leading to task correction. That is, as the above-described “mechanism 1”, interactive task design/correction by dialogue is realized. In addition, it has a function of acquiring business know-how or the like from the dialogue content, storing the business know-how or the like as formal knowledge, and enabling reference.

In the present embodiment, the history of the dialogue content with the user 2 is classified into four types of combinations of long term/short term/objective/subjective and stored, and timings and use methods to be used are organized. For example, while the current exchange (dialogue log) with the user 2 is stored on the memory as a short-term storage 16 so as to be able to be referred to in real time, the past exchange (session log) is stored in a database as a long-term storage 15, is referred to by search when necessary, and is used to generate a response (RAG: Retrieval-Augmented Generation, search enhancement generation).

In addition, regarding the content to be stored, objective fact storage such as a dialogue log and subjective variable storage such as a summary of the dialogue and information regarding next correspondence predicted from the summary content are distinguished, the former held in real time during the dialogue is stored as a short-term objective storage 16a, and the latter is stored as a short-term subjective storage 16b. In addition, after the dialogue, the text data of the objective dialogue log is stored in the database as a long-term objective storage 15a, and the text data of the summary of the subjective dialogue record is stored in the database as a long-term subjective storage 15b, so as to be able to be appropriately referred to at the time of the subsequent response. That is, functions of dialogue summary and long-term storage management are realized as the above-described “mechanism 2”.

With such an architecture, it is possible to realize the agent-type AI capable of overcoming the problems of the agent-type AI using the existing generative AI as described above, appropriately understanding the execution situation of the business, and autonomously designing and executing the task.

That is, the agent-type AI in the present embodiment has a mechanism for extending the agent-type AI utilizing the existing generative AI, and understands the business background and the business situation through the dialogue with the user without requiring specific and detailed instructions by the user, and recognizes the goal to be achieved by clarifying the business problem. Then, from the abstract instruction of the user, individual tasks necessary for achievement of the goal are autonomously listed and decomposed into specific instruction contents, and each task is autonomously executed after reaching an agreement with the user on the work content, thereby realizing achievement of the goal. This assists the business of the user, contributes to reduction of the business load and innovation of the business flow, and realizes drastic business transformation.

### <System Configuration>

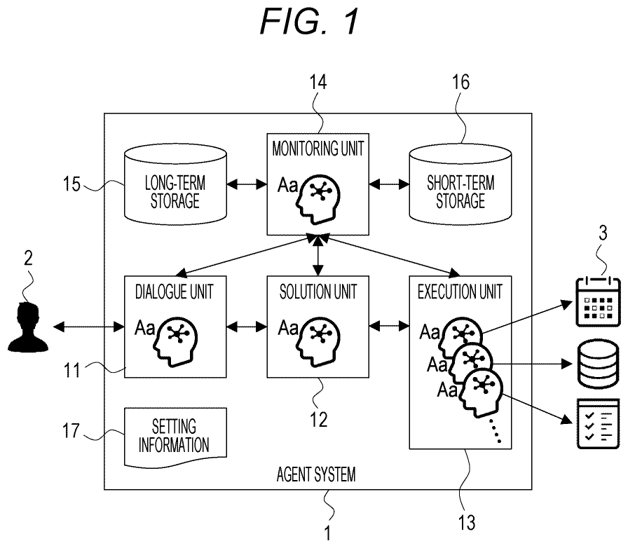

FIG. 1 is a diagram illustrating an outline of a configuration example of the agent system that is one embodiment of the present invention. The agent system 1 includes, for example, a server device, a virtual server built on a cloud computing service, and the like, and implements each function as an agent-type AI by using middleware such as an operating system (OS), a database management system (DBMS), a web server program, or the like developed on a memory from a recording device such as a hard disk drive (HDD) or a solid state drive (SSD) by a central processing unit (CPU) (not illustrated), software operating on the middleware, a response application programming interface (API) of various LLM services, or an LLM model built in a local environment.

The agent system 1 includes, for example, each unit (AI mechanism) such as a dialogue unit 11, a solution unit 12, an execution unit 13, and a monitoring unit 14 implemented as software. In addition, the agent system 1 includes each data store, such as the long-term storage 15, the short-term storage 16, and the setting information 17, which is implemented by a database, a file, or the like.

The dialogue unit 11 is an AI mechanism including (or using) the dialogue AI (11a) of FIG. 2 described above, and has a function of interacting with the user 2 via the input text from the user 2. Then, the dialogue unit 11 has a function of extracting a problem through dialogue with the user 2 and interpreting and clarifying a business instruction. In the dialogue with the user 2, for example, a dialogue content specific to the user 2 can be obtained by referring to various types of information set in the setting information 17. The content of the dialogue is stored as a dialogue log in real time in the short-term storage 16.

The solution unit 12 is an AI mechanism including (or using) the above-described solution AI (12a) of FIG. 2, and has a function of decomposing the business instruction clarified by the dialogue unit 11 into specific business work items (tasks) and instructing the execution unit 13 described later to execute each task. Accordingly, the user 2 does not need to instruct each work content specifically and in detail, and even if the work instruction is a complex or abstract work instruction, the solution unit 12 adapts to an appropriate work instruction, so that a target work result can be obtained, and the above-described [Problem 3] of the need for specific and detailed instructions can be solved.

Then, the solution unit 12 shapes and lists the execution instructions of each task as text information including information required by the execution AI (13a) corresponding to the task, passes the work instruction text to the execution unit 13 to be described later for each target execution AI (13a) to execute each work, and acquires a result. The solution unit 12 summarizes the work content performed by the execution unit 13 and presents the summary to the user 2 through the dialogue unit 11.

The execution unit 13 is an aggregate of AI mechanisms including (or using) a plurality of execution AIs (13a) in FIG. 2 described above, and each AI mechanism has a function of executing each decomposed business work item (task). Each AI mechanism has a corresponding individual data source 3. The data source 3 is, for example, various databases, a business management application, an API of an external data source, or the like, and each AI mechanism grasps a work procedure for work (for example, information acquisition or information processing) with respect to the corresponding data source 3, executes the work by receiving an appropriate instruction from the solution unit 12, and acquires data from the data source 3.

In a case where information necessary for execution of processing in the AI mechanism is not included in the input of the instruction passed from the solution unit 12, for example, information recorded in the short-term storage 16 via the monitoring unit 14 to be described later is referred to, and it is confirmed whether necessary information exists. In a case where there is no information in the short-term storage 16, the monitoring unit 14 may instruct the dialogue unit 11 to execute an inquiry to the user 2, and the dialogue unit 11 may acquire necessary information by inquiring of the user 2 about insufficient information.

In addition, in a case where the instruction content from the solution unit 12 cannot be resolved by using the data source 3 included in the target execution AI (13a), this fact is returned to the solution unit 12, and the change of the work content is requested. Accordingly, the solution unit 12 refers to the content pointed out by the execution AI (13a) for the work instruction and corrects the work instruction. In the correction of the work instruction, the solution unit 12 refers to the history information (short-term storage 16) of the dialogue created by the monitoring unit 14 to be described later, and performs correction in accordance with the work instruction of the user 2. By the dialogue between the solution unit 12 and the execution unit 13, an inexecutable task in the above-described [Problem 4] is dealt with.

The monitoring unit 14 is an AI mechanism including (or using) the monitoring AI (14a) of FIG. 2 described above, and has a function of interpreting text information exchanged among the user 2, the dialogue unit 11, the solution unit 12, and the execution unit 13, organizing the information, and storing the information in the long-term storage 15 or the short-term storage 16.

That is, the monitoring unit 14 sequentially refers to the text information exchanged among the user 2, the dialogue unit 11, the solution unit 12, and the execution unit 13, extracts a situation regarding information that is regarded as important in business execution, and stores the situation as a summary. This information is accumulated as text data in the short-term storage 16, and is referred to in real time in the dialogue unit 11, the solution unit 12, and the execution unit 13. The important information to be extracted by the monitoring unit 14 is defined in advance in the setting information 17, for example, and by the function of the generative AI, these pieces of information are extracted from the text information exchanged in each unit by using sentences and keywords, the context of the dialogue session is grasped, and then contents to be dealt with next are predicted and proposed.

Then, the monitoring unit 14 organizes, as business know-how, information regarding the work instruction or the work item performed by the user 2 via the dialogue unit 11, the execution result in the execution unit 13, and the like, and stores the information as the long-term subjective storage 15b. In the long-term subjective storage 15b, the organized information is held as text data and embedding (embedded expression) obtained by the monitoring AI (14a), and is used, for example, as reference information when the user 2 executes a work instruction similar to the past work in addition to being used for understanding of the latest situation of the user 2, the orientation of the work, the business background, and the like in the next or later dialogue with the user 2. Accordingly, the dialogue unit 11, the solution unit 12, and the execution unit 13 can interpret the intention and orientation of the user 2 to overcome the above-described [Problem 1] and improve the understanding of the business background and the business instruction.

Note that, in the configuration example of FIG. 1, each of the dialogue unit 11, the solution unit 12, the execution unit 13, and the monitoring unit 14 is configured as an AI mechanism including generative AI (or using the generative AI), but the generative AIs may use systems or services of different generative AIs, or one or more generative Als may use systems or services of the same generative AI. In addition, in the configuration example of FIG. 1, all the above-described units are described in a form of being included in the server system of the agent system 1, but this is merely a logical configuration, and it goes without saying that one or more units may be physically configured as a subsystem by another server system and function in cooperation.

### <Problem Solving Method>

As described above, the present embodiment is an agent-type AI capable of overcoming the above-described [Problem 1] to [Problem 4] of existing generative AI and agent-type AI using the generative AI by including the above-described “mechanism 1” to “mechanism 4”, and realizing drastic business transformation.

### Solution to [Problem 1] by “Mechanism 1”

As an improvement measure for solving [Problem 1] that execution propriety/execution situation of a task cannot be controlled according to interactive dialogue with the user 2 in an agent-type AI using existing generative AI, in the present embodiment, the dialogue unit 11 receives a task list created by the solution unit 12 and presents the task list to the user 2, and instructs the solution unit 12 to execute the task in a case where an agreement of execution is obtained from the user 2. At that time, the user 2 can request an additional task for the proposed task list or request correction of the content of the proposed task.

Such a dialogue between the dialogue unit 11 and the user 2 is recorded as a dialogue log at any time, and a summary is created by the monitoring unit 14. Then, the solution unit 12 creates an instruction for work to be executed. In addition, the solution unit 12 refers to the matter to be dealt with, the dialogue log, and the summary of the dialogue created by the monitoring unit 14, and executes the correction when the user 2 requests the correction of the task list. In addition, also when the execution unit 13 actually executes the task list with the agreement of the user 2, the dialogue unit 11 can inquire of the user 2 about information necessary for execution of the task as necessary.

As described above, in the present embodiment, the response matter required by the user 2, that is, the response matter to be executed next by the agent system 1 is held in the short-term subjective storage 16b by the cooperation of the dialogue unit 11 and the monitoring unit 14, so that the requested task can be autonomously executed while maintaining interactive dialogue with the user 2.

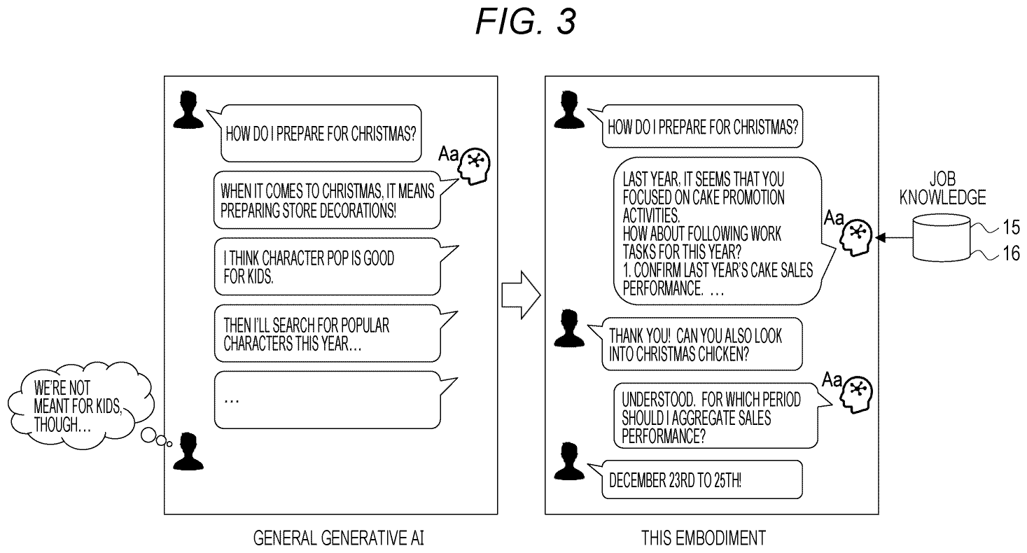

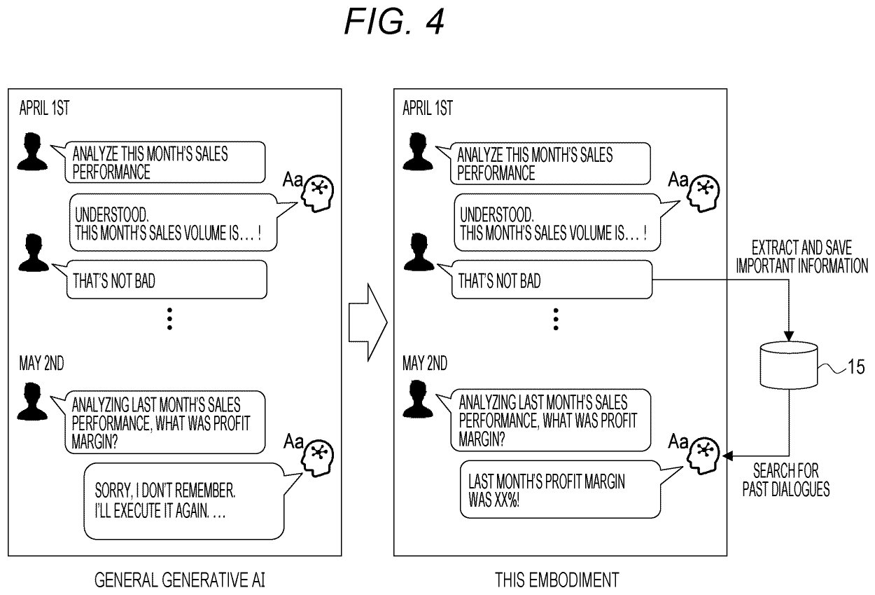

FIG. 3 is a diagram illustrating an outline of a solution example of [Problem 1] by the “mechanism 1” in one embodiment of the present invention. In the drawing, a screen example of the content of the dialogue between the user 2 and the general generative AI is illustrated on the left side, and in the drawing on the right side, an example is illustrated in which the solution is attempted by the agent system 1 of the present embodiment in a similar situation (the same applies to the following FIGS. 4 to 6). In the general dialogue on the left side, the agent-type AI unilaterally interprets an abstract inquiry by the user 2 and advances the dialogue, whereas in the dialogue in the present embodiment on the right side, a situation is illustrated in which the content of the task is narrowed and embodied while the user and the agent system 1 engage in an interactive dialogue.

Specifically, the monitoring unit 14 (monitoring AI (14a)) aggregates the important information of the dialogue from the latest dialogue log (short-term objective storage 16a) as the short-term storage 16 (short-term subjective storage 16b), searches the past conversation history (long-term subjective storage 15b) on the basis of the information, and determines the topic switching in real time with reference to the history having the highest similarity, so that the user 2 can correct the content of the task at any time during the dialogue, and interactively input an instruction according to intention to the dialogue unit 11 (conversation AI (11a)). In addition, the monitoring unit 14 grasps in advance information minimum necessary for execution of each task with reference to the setting information 17 and the like, and thus even in a case where information necessary for execution of the task is insufficient in an instruction from the user 2, it is possible to design an executable task by inquiring of the user 2 before the execution of the task.

### Solution to [Problem 2] by “Mechanism 2”

In the agent-type AI using the existing generative AI, in order to overcome [Problem 2] that although the latest dialogue content can be stored, the past dialogue content cannot be accumulated, be stored for a long period of time, and be referred to, in the present embodiment, the agent-type AI can continuously store the business background and the business situation for a long period of time from the dialogue content with the user 2. That is, when the dialogue with the user 2 ends, the monitoring unit 14 extracts and summarizes, from the performed dialogue content, information considered to be important for understanding of the current business background and the future business instruction, such as the request matter of the user 2, the design content of the task by the agent, the execution result of the task, the evaluation of the user 2 with respect to the execution result, or the orientation of the desire of the user 2 with respect to the agent, and stores the result as the long-term subjective storage 15b in the database.

In this summary, keywords important for grasping the business background and the business situation are extracted and stored in the database so as to be used at the time of searching the dialogue record. With this mechanism, when interacting with the user 2 from the next time, the agent-type AI can appropriately refer to the summary information of the past dialogue similar to the current dialogue and be useful for smooth dialogue with the user 2.

FIG. 4 is a diagram illustrating an outline of a solution example of [Problem 2] by the “mechanism 2” in one embodiment of the present invention. In the dialogue with the general generative AI on the left side, the content answered by the agent-type AI in the dialogue on April 1 is not memorized and cannot be answered in the dialogue on May 2, but in the dialogue in the present embodiment on the right side, a situation is illustrated in which in the dialogue on May 2, the content can be answered on the basis of the content answered in the dialogue on April 1 by searching the past dialogue.

Specifically, in the dialogue unit 11 (dialogue AI (11a)), “user's intention”, “latest dialogue history”, and the like are acquired from the long-term storage 15 by the RAG and referred to, thereby realizing a conversation that has succeeded the past storage. At this time, by performing RAG on the summary recorded in the long-term subjective storage 15b instead of the raw dialogue log of the conversation session recorded in the long-term objective storage 15a, it is possible to improve the accuracy of search. This is because the raw dialogue log is predominantly occupied by the speech by the dialogue AI (11a), and the speech and intention of the user are not easily referred to, and it is possible to aggregate necessary information by summarizing the dialogue content in the monitoring unit 14 (monitoring AI (14a)) at the end of the dialogue session. For example, by summarizing the characteristics of the user 2 such as “Mr. A prefers a short response”, it is also possible to give a personalized response according to the preference of each user 2.

### Solution to [Problem 3] by “Mechanism 3”

In order to solve [Problem 3] that it is not possible to deal with an abstract and complex instruction content not specified in an execution requirement in the agent-type AI using an existing generative AI, the user 2 can give a business instruction as an abstract or complex natural dialogue without considering a determination criterion of the agent-type AI.

That is, in the present embodiment, in a case where, in the dialogue unit 11, an agreement is reached on an instruction with a high abstraction and a complex task content through the dialogue between the user 2 and the agent-type AI, the dialogue unit 11 issues an execution queue to the solution unit 12, and the solution unit 12 decomposes the work instruction of the user 2 into specific work items with reference to the summary of the dialogue created by the monitoring unit 14, the work to be executed next, the instruction of the user 2, and the past instruction of the user 2 and the task design result similar to the instruction of the user 2 acquired from the long-term subjective storage 15b.

Regarding the work decomposition method, in the prompt input to the solution unit 12, a work content that can be executed by the execution unit 13 and a case of a work goal to be created and a task list to be created from an instruction of the user 2 are exemplified, and thus the solution unit 12 can autonomously create a task list intended by the user 2 on the basis of these pieces of information. In this task list, the name of the execution AI (13a) that is to execute the task in the execution unit 13 and the specific work content given to the execution AI (13a) are indicated, and by sequentially executing these, it is possible to execute an abstract and complex business instruction instructed by the user 2.

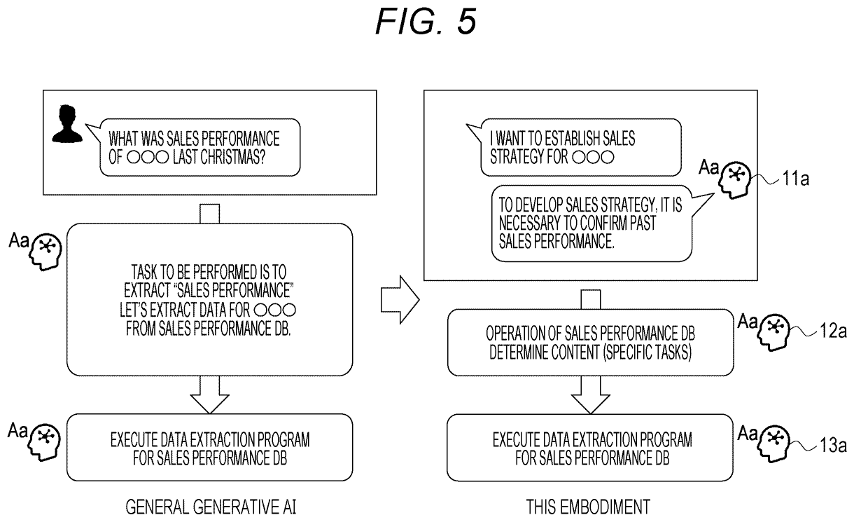

FIG. 5 is a diagram illustrating an outline of a solution example of [Problem 3] by the “mechanism 3” in one embodiment of the present invention. In the general dialogue on the left side, in response to a task request (“inquiry of sales performance” in the example in the drawing) of specific content from the user, an appropriate task (“extract sales performance”) to be performed by the agent-type AI is determined, and the target generative AI (“sales performance AI”) is caused to execute the task.

On the other hand, in the dialogue in the present embodiment on the right side, a situation is illustrated in which the execution unit 13 (execution AI (12a)) (“sales performance AI”) that receives a task request (“I want to establish sales strategy” in the example in the drawing) having an abstract content from the user 2, embodies a task to be performed by the solution unit 12 (solution AI (13a)) of the agent system 1 (“confirm sales performance”), and executes the task is determined and executes the task.

As described above, in general generative AI and agent-type AI, an appropriate response can be made to a specific task execution instruction from the user, but an appropriate response cannot be made with an abstract task execution instruction. On the other hand, in the present embodiment, it is possible to appropriately interpret and execute an abstract task execution instruction by dividing roles between the solution unit 12 (solution AI (12a)) that concretizes an abstract task into a specific task and the execution unit 13 (execution AI (13a)) that receives and executes an instruction of an embodied task.

### Solution to [Problem 4] by “Mechanism 4”

In the agent-type AI using the existing generative AI, in order to solve [Problem 4] (frame problem) that when the execution of the task is determined by comparing the instruction content of the user 2 with the execution requirement, the determination is often deviated from the realistic determination, and thus in the present embodiment, the agent-type AI corrects the task list, which is created by the agent-type AI, through the dialogue between the AIs about whether the work can be solved in an external data source or an executable function (Tool) of the agent-type AI, and corrects the task list to an executable range.

The solution unit 12 creates a task list to be executed, confirms whether there is correction by the user 2 through the dialogue unit 11, sequentially reads the task list if there is no need for correction, and passes the created specific work instruction to the listed relevant execution AI (13a) of the execution unit 13. The execution AI (13a) of the execution unit 13 has the data source 3 and has an executable function (Tool) for the data source 3.

The execution AI (13a) corresponds to the agent-type AI using existing generative AI, and inquires an execution criterion of an executable function of the execution AI and input instruction content according to specific and detailed instruction content, and executes the relevant function (Tool). At this time, the target execution AI (13a) determines whether the passed work instruction is a task executable by the execution AI and whether a parameter necessary for execution is included in the instruction content, and in a case where the work instruction is inexecutable, the target execution AI (13a) points out that the work instruction is an inexecutable task and requests the solution unit 12 to correct the task. The solution unit 12 corrects the relevant task in response to a request from the execution AI (13a) so as to have executable content.

In addition, in a case where the work instruction from the user 2 is appropriate, but the parameter necessary for the work is not included in the instruction content, the execution AI (13a) refers to the short-term subjective storage 16b created by the monitoring unit 14, and attempts to extract the parameter necessary for the work from the summary of the dialogue, and when the relevant information can be referred to, autonomously supplements the parameter to execute the given task.

In a case where information that can supplement the relevant parameter is not given even by referring to the short-term subjective storage 16b, the execution AI (13a) executes a question about a necessary parameter to the user 2 by the dialogue unit 11 through the solution unit 12. In a case where the user 2 has answered a necessary parameter, the execution AI (13a) executes the task using the parameter. Accordingly, the agent-type AI can correct incompleteness of the task instruction through interactive dialogue between the agent-type AIs or between the agent-type AI and the user 2, and execute each task while avoiding the frame problem.

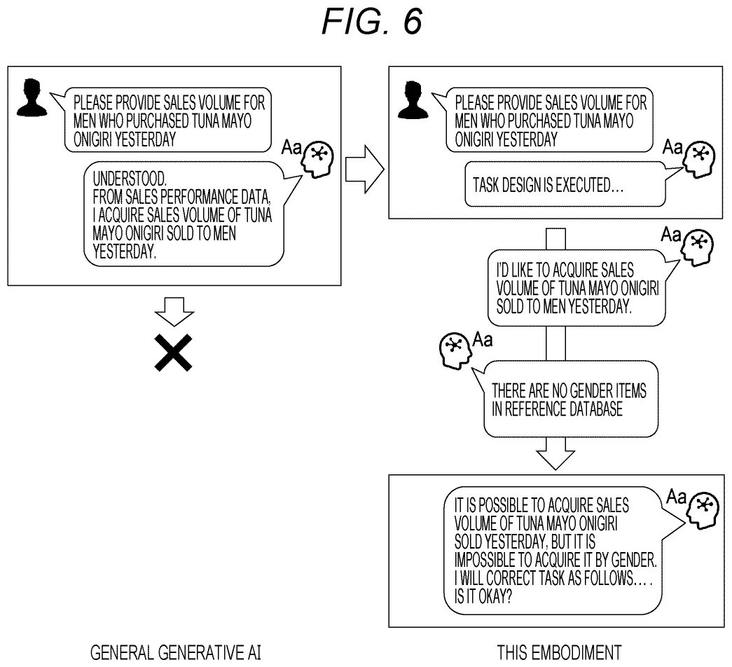

FIG. 6 is a diagram illustrating an outline of a solution example of [Problem 4] by the “mechanism 4” in one embodiment of the present invention. In the general dialogue on the left side, a situation is illustrated in which the user inquires about the sales performance of “male”, but the agent-type AI cannot execute the task since the database to be referred to does not include the item “gender”, and despite of this, the agent-type AI cannot grasp the limit (frame) of the task that the agent-type AI can execute and thus designs an inexecutable task. On the other hand, in the dialogue in the present embodiment on the right side, a situation is illustrated in which the agent system 1 grasps its own limit (frame) that there is no item of “gender” in the reference database, and thus can design and execute an appropriate task by causing the agent-type AIs to interact with each other.

As described above, in general agent-type AI, there is a case where the agent-type AI performs task design exceeding a task that can be executed by the agent-type AI (frame problem). However, in the present embodiment, by referring to “business knowledge (past knowledge)” by the RAG in response to a request from the user, it is possible to acquire contents of a similar task and a task executed in the past, grasp the limit (executable range) of the agent-type AI, and design an appropriate task. In addition, by the monitoring unit 14 at the end of the session, the created task design is accumulated in the long-term objective storage 15a in association with the instruction content of the user 2, the created task design, and the evaluation of the user 2 on the execution result, and is utilized for the subsequent task design. Accordingly, in a case where a similar instruction is executed next time or later, it is possible to realize task design based on the orientation of the user 2.

### <Flow of Process>

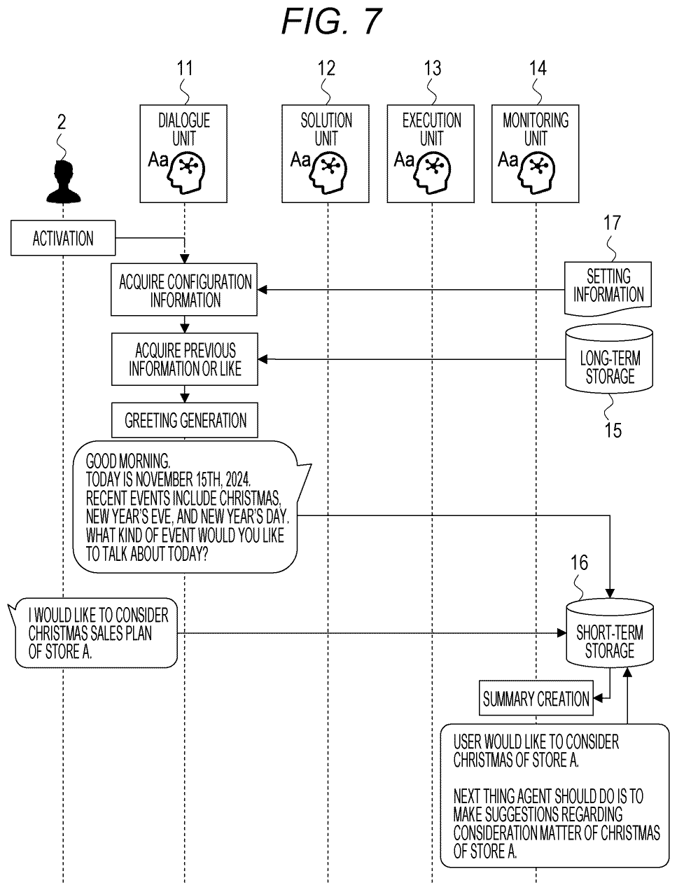

FIGS. 7 to 13 are diagrams illustrating an outline of an example of a processing flow in one embodiment of the present invention. Here, as an example of a flow of task execution by dialogue between the user 2 and the agent system 1, a scene is assumed in which the agent system 1 collects related information in advance when the user 2 who is a person in charge of a member store in an operating organization of a franchise store discusses what sales promotion activity should be performed with a store in charge for a specific event.

As a specific flow, dialogue is performed with reference to a past dialogue history with the user 2, a task is designed in accordance with a request of the user 2 while grasping the business background and the business situation of the user 2, and the task design is corrected while engaging in an interactive dialogue. Then, the designed task is executed by each execution AI (13a), and in a case where there is an incompleteness or insufficiency in the instruction input for execution, an inquiry is made to the user 2. Then, the task is executed to collect a result, and the collected data is summarized and presented to the user 2. In addition, when the dialogue is ended, the content of the dialogue with the user 2 is stored by the monitoring unit 14 so as to be usable for the subsequent response, and the work result and the evaluation of the user 2 with respect to the work result are also stored, thereby extracting the orientation of the user 2 and contributing to long-term storage and reference of the dialogue with the user 2.

In FIG. 7, first, the user 2 activates an application that accesses the agent system 1 by using an information processing terminal (not illustrated) such as a PC or a smartphone (or accesses a service of the agent system 1 using a web browser). At the time of activation, the dialogue unit 11 acquires various types of information such as information of the user 2, date, store information, and event information from the setting information 17. In addition, a summary log of the previous session of the user 2 and the like are acquired from the long-term storage 15.

Then, the dialogue unit 11 creates a prompt for generating a dialogue with the user 2, generates a greeting sentence at the start of a session by the dialogue AI (11a), and presents the generated sentence to the user 2. In the example in the drawing, the work situation of the latest session from the date of the current day is checked, the closest event and the information of the previous year are presented, and an inquiry is made about which event to talk about.

The text information (“Christmas . . . of store A”) of the greeting presented by the dialogue unit 11 and the response from the user 2 to the greetings is stored as a dialogue log in the short-term storage 16 (short-term objective storage 16a). Thereafter, the monitoring unit 14 creates a summary from the content of the dialogue log recorded in the short-term storage 16 by the monitoring AI (14a), and stores the summary as a summary log in the short-term storage 16 (short-term subjective storage 16b). Note that, at the end of the summary, the content determined as a matter to be dealt with next on the basis of the dialogue content (“make suggestions regarding consideration matter of Christmas of store A”) is described.

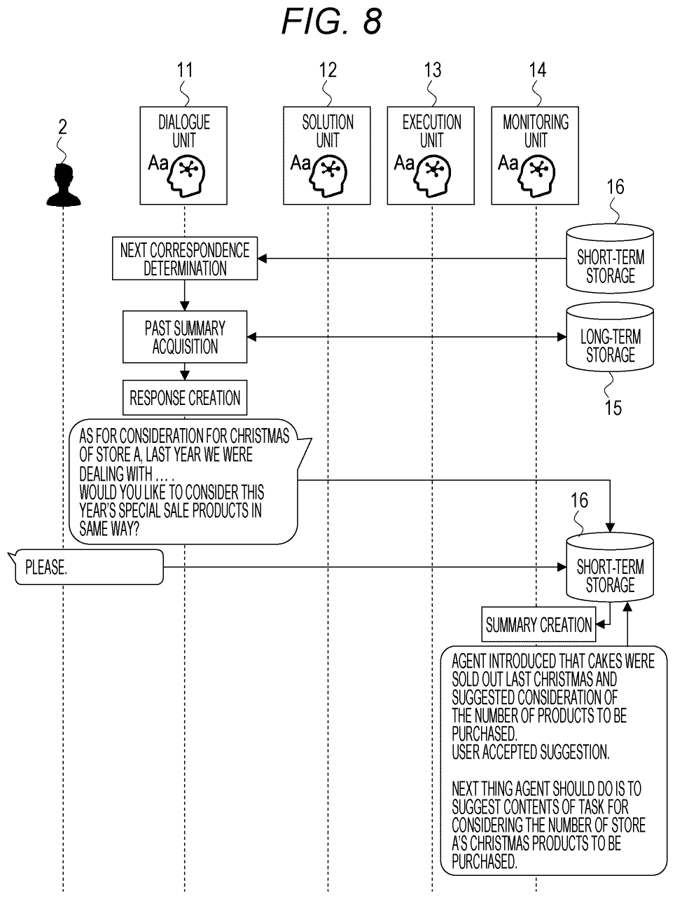

Thereafter, the processing proceeds to FIG. 8, and the dialogue unit 11 acquires and refers to the input content including the response from the user 2 and the summary created by the monitoring unit 14 (monitoring AI (14a)) and the content of the matter to be dealt with next described in the summary from the short-term storage 16, creates a prompt for determining whether the solution unit 12 will make the next response or the dialogue unit 11 itself will continue to make the response, and inputs the prompt to the dialogue AI (11a) to determine the AI mechanism to make the next response. In the example of FIG. 8, it is assumed that it is determined that the dialogue unit 11 continues to deal with the next time.

As the next response, the dialogue unit 11 searches the past dialogue log stored in the long-term storage 15 on the basis of the input content from the user 2, and acquires a summary of a similar past dialogue (session) on the basis of the search result. Then, a prompt to generate a response content to the user 2 is created on the basis of the input content from the user 2, the dialogue log and the summary of the current session, and the summary of the past session, and is input to the dialogue AI (11a), so that the response content is created and presented to the user 2. In the example in the drawing, a response content of last year is illustrated, and an inquiry is made as to whether to similarly consider this year.

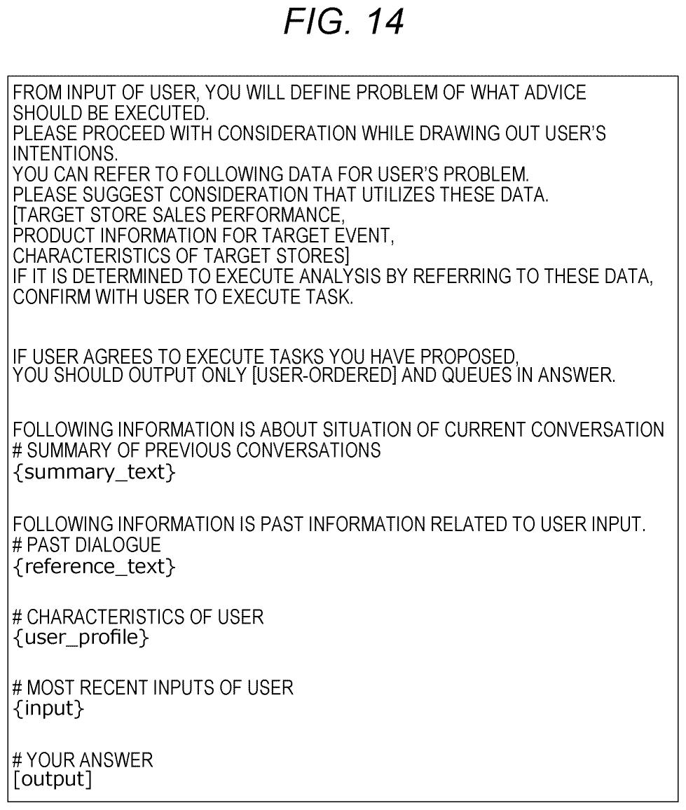

FIG. 14 is a diagram illustrating an outline of an example of a prototype of a prompt of the dialogue unit 11 that generates a response to the user in one embodiment of the present invention. “{summary_text}” in the drawing is read from the short-term subjective storage 16b and replaced. In addition, “{user_profile}” is reads from the setting information 17 and replaced with a corresponding value. In addition, in the variable of “{reference_text}”, a summary is acquired from the long-term subjective storage 15b, and a past similar dialogue is embedded. In this way, a prompt is dynamically created by the replacement of the variable or the like and is input to the dialogue AI (11a), so that it is possible to generate a response personalized to the user 2 as illustrated in the example of FIG. 8.

Returning to FIG. 8, the response content presented by the dialogue unit 11 and the text information of the response from the user 2 to this are stored as a dialogue log in the short-term storage 16 (short-term objective storage 16a). Thereafter, the monitoring unit 14 creates a summary from the content of the dialogue log recorded in the short-term storage 16 by the monitoring AI (14a), and stores the summary as a summary log in the short-term storage 16 (short-term subjective storage 16b). Note that, at the end of the summary, the content determined to be dealt with next on the basis of the dialogue content (“suggest contents of task for considering the number of store A's Christmas products to be purchased”) is described.

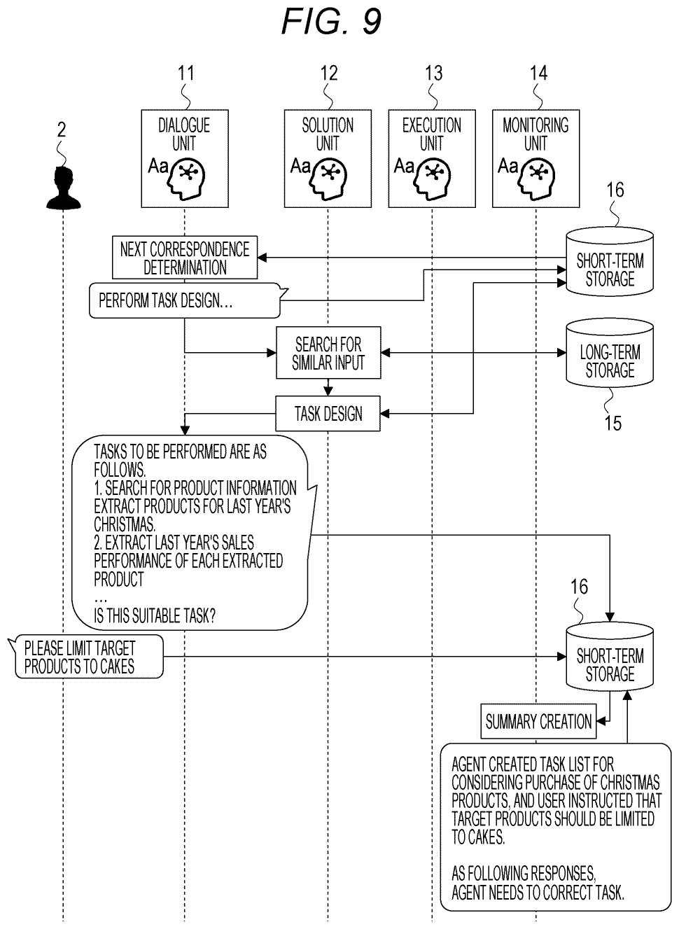

Thereafter, the processing proceeds to FIG. 9, and the dialogue unit 11 acquires and refers to the input content including the response from the user 2 and the summary created by the monitoring unit 14 (monitoring AI (14a)) and the content of the matter to be dealt with next described in the summary from the short-term storage 16, creates a prompt for determining whether the solution unit 12 will make the next response or the dialogue unit 11 itself will continue to make the response, and inputs the prompt to the dialogue AI (11a) to determine the AI mechanism to make the next response. In the example of FIG. 9, next, it is assumed that the solution unit 12 determines to design a task, and the dialogue unit 11 presents that determination (“perform task design”) to the user 2.

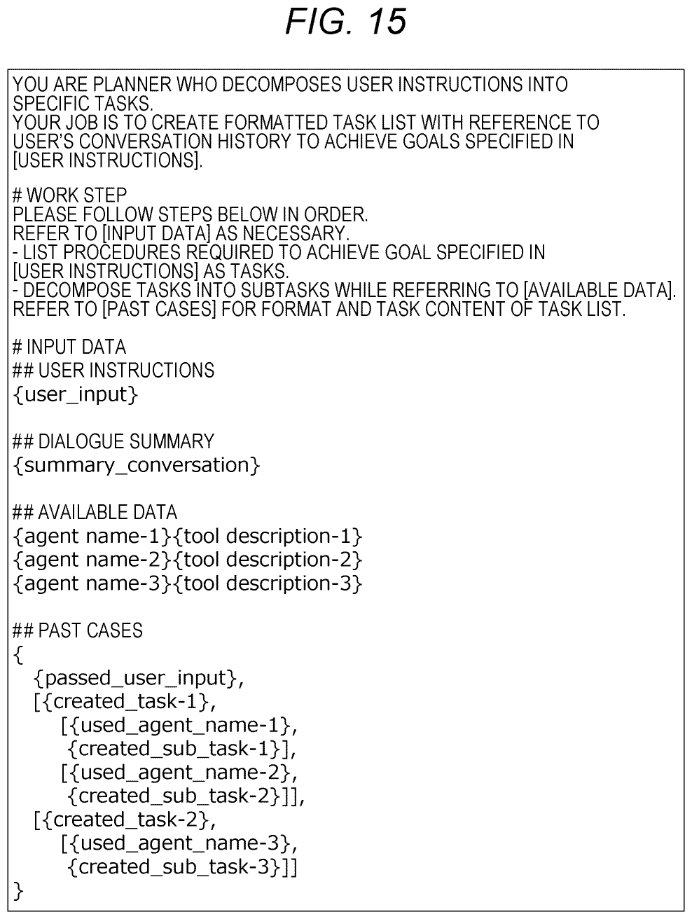

FIG. 15 is a diagram illustrating an outline of an example of a prompt of the solution unit 12 that creates a task list in one embodiment of the present invention. In the drawing, it is instructed to decompose the task with reference to the “user instruction” and create a task list executable by the execution unit 13. Regarding the task executable by the execution unit 13, the name of each execution AI (13a) and the description text of an executable function (Tool) are described in “available data”. In addition, in the “past case”, a task list created for a past user instruction similar to the input content from the user 2 is embedded.

The task list is defined as a format such as a JavaScript Object Notation (JSON) format, and is output as a decomposable list so that the application sequentially executes the task after the output. In this example, the user instruction is decomposed into individual tasks, and a specific instruction for a function (Tool) that can be executed by each execution AI (13a) is output as a necessary subtask in each task. Through such a task decomposition procedure, it is possible to specifically concretize an abstract and complex instruction of the user 2.

Returning to FIG. 9, the solution unit 12 that has received an instruction to perform the next response from the dialogue unit 11 refers to the past dialogue (session) log and the summary log stored in the long-term storage 15 on the basis of the input content from the user 2, searches for a similar past input from the user 2, and reads and acquires a case of task design corresponding to the obtained past input (dialogue log) from the long-term storage 15.

Thereafter, the task design is performed by referring to the acquired case of the task design, creating a prompt for executing the task design corresponding to the input of the user 2, and inputting the prompt to the solution AI (12a). For example, the result of the task design is stored in the short-term storage 16 as a task list in which what kind of instruction is given to which execution AI (13a) for each work item is described in JSON format. Then, the JSON-format task list is formatted into text and presented to the user 2 via the dialogue unit 11.

In the example of FIG. 9, in response to the presentation of the task list by the dialogue unit 11, the user 2 responds that “please limit target products to cakes”, and these pieces of text information are each stored as a dialogue log in the short-term storage 16 (short-term objective storage 16a). Thereafter, the monitoring unit 14 creates a summary from the content of the dialogue log recorded in the short-term storage 16 by the monitoring AI (14a), and stores the summary as a summary log in the short-term storage 16 (short-term subjective storage 16b). Note that, at the end of the summary, the content determined as a matter to be dealt with next on the basis of the dialogue content (“as following responses, agent needs to correct task”) are described.

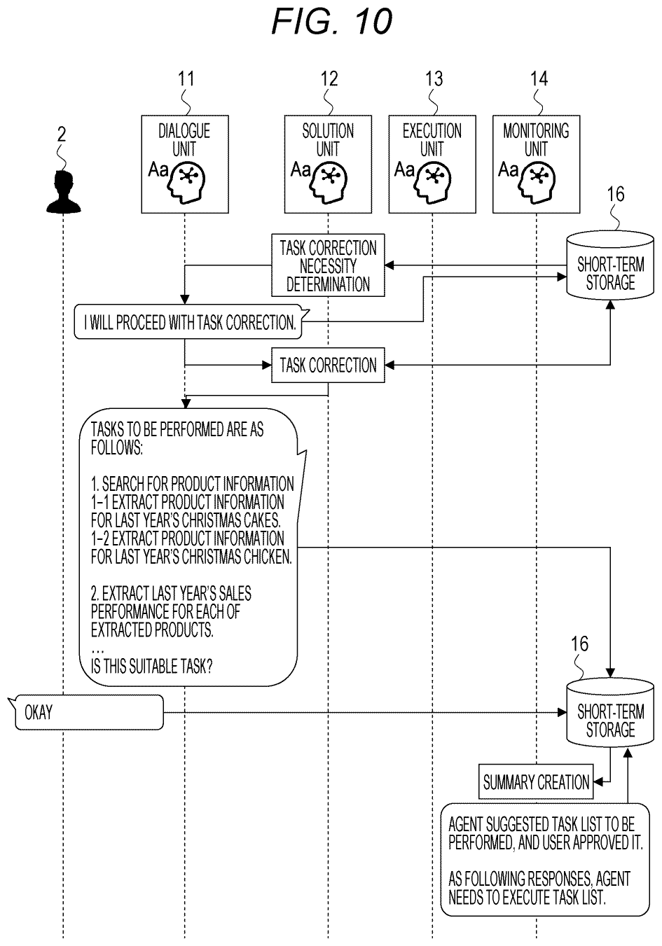

Thereafter, the processing proceeds to FIG. 10, and the solution unit 12 acquires and refers to the input content including the response from the user 2, the summary created by the monitoring unit 14 (monitoring AI (14a)), and the content of the matter to be dealt with next described in the summary from the short-term storage 16, and determines whether the task needs to be corrected. In the example of FIG. 10, it is assumed that it is determined that the task needs to be corrected, and the determination (“I will proceed with task correction”) is presented to the user 2 via the dialogue unit 11, then the task is corrected with reference to the dialogue log stored in the short-term storage 16 and the designed task list, and the content of the corrected task is presented to the user 2 via the dialogue unit 11.

Then, the content of the task presented by the dialogue unit 11 and the text information of the response from the user 2 to the content are stored as a dialogue log in the short-term storage 16 (short-term objective storage 16a). Thereafter, the monitoring unit 14 creates a summary from the content of the dialogue log recorded in the short-term storage 16 by the monitoring AI (14a), and stores the summary as a summary log in the short-term storage 16 (short-term subjective storage 16b). Note that, at the end of the summary, the content determined as a matter to be dealt with next on the basis of the dialogue content (“execute task list”) are described.

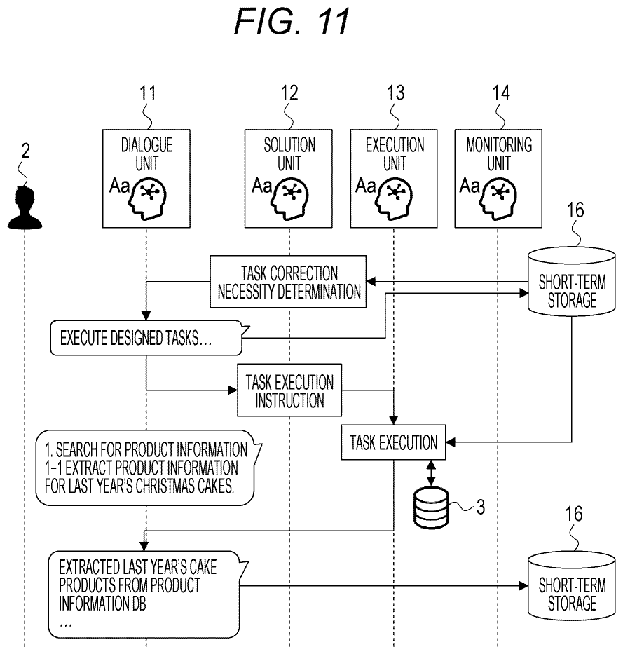

Thereafter, the processing proceeds to FIG. 11, and the solution unit 12 acquires and refers to the input content including the response from the user 2, the summary created by the monitoring unit 14 (monitoring AI (14a)), and the content of the matter to be dealt with next described in the summary from the short-term storage 16, and determines again whether the task needs to be corrected. In the example of FIG. 11, it is assumed that it is determined that the task does not need to be corrected, and the task execution is presented to the user 2 via the dialogue unit 11, and then the tasks in the task list are sequentially (in parallel if possible) passed to the execution unit 13 to instruct execution. Specifically, a text in which an instruction for executing the target task is described is passed to the execution unit 13, and the content of the task (in the example of FIG. 11, “task 1-1: extract product information for last year's Christmas cakes . . . ”) is presented to the user 2 via the dialogue unit 11.

In the example of FIG. 11, the execution of “task 1-1” is instructed, and the execution unit 13 creates a prompt for execution of the task with reference to the task execution instruction passed from the solution unit 12, and the dialogue log and the summary log stored in the short-term storage 16 and executes the task by inputting the prompt to the corresponding execution AI (13a). In the execution AI (13a), a work (for example, information acquisition or information processing) using the corresponding data source 3 is executed, and an execution result is text-shaped to be presented to the user 2 via the dialogue unit 11. The content of the presented dialogue is stored as a dialogue log in the short-term storage 16 by the dialogue unit 11.

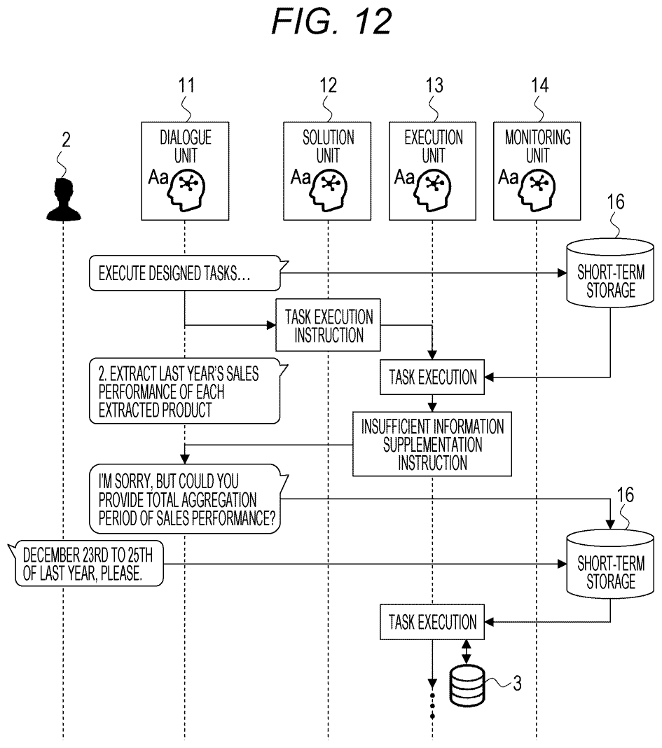

Thereafter, the processing proceeds to FIG. 12, and the solution unit 12 passes the next task to the execution unit 13 and instructs execution. Specifically, a text in which an instruction for executing the target task is described is passed to the execution unit 13, and the content of the task (“task 2: . . . last year's sales performance for each of extracted products”) is presented to the user 2 via the dialogue unit 11.

In the example of FIG. 12, the execution of the “task 2” is instructed, and the execution unit 13 creates a prompt for executing the task with reference to the task execution instruction passed from the solution unit 12 and the dialogue log and the summary log stored in the short-term storage 16, and executes the task by inputting the prompt to the corresponding execution AI (13a). However, in the example of FIG. 12, it is assumed that the instruction content of the task execution, the dialogue log, the summary log, and the like do not include information necessary for the task execution and are insufficient. In this case, for example, in accordance with the indication and instruction included in the response from the execution AI (13a), the execution unit 13 presents, to the user 2 via the dialogue unit 11, an instruction to supplement the insufficient information (in the example in the drawing, “aggregation period”).

The content of the supplementation instruction presented by the dialogue unit 11 and the text information of the response from the user 2 to the content are each stored as a dialogue log in the short-term storage 16 (short-term objective storage 16a). Then, the execution AI (13a) executes the task on the basis of the content supplemented from the user 2. Thereafter, subsequent tasks in the task list are sequentially executed similarly.

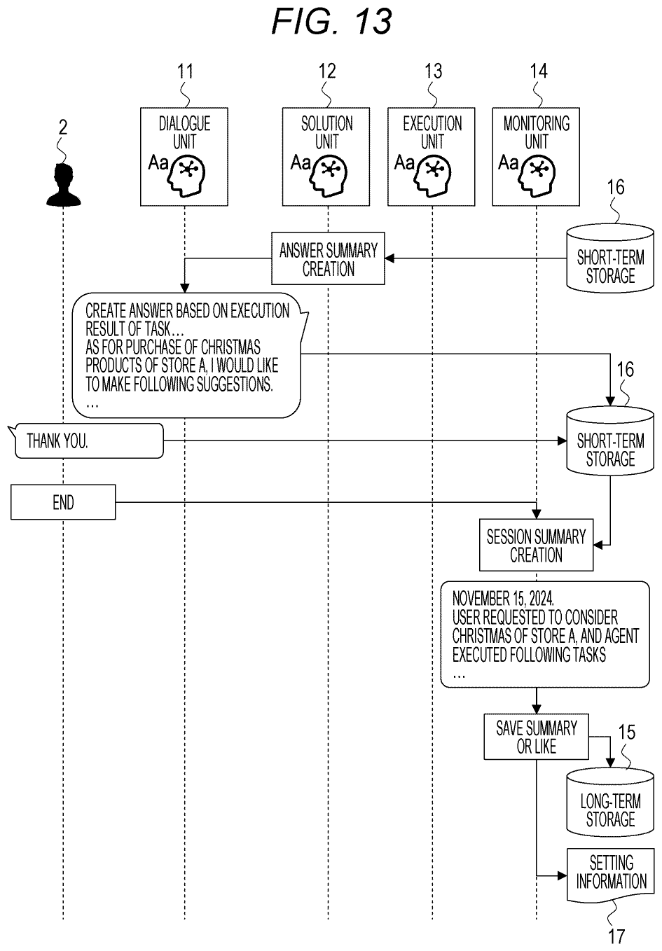

Thereafter, the processing proceeds to FIG. 13, when the execution of all the tasks in the task list is ended, the solution unit 12 creates a prompt for generating an answer by putting together, from the short-term storage 16, the input content including the response from the user 2, the summary created by the monitoring unit 14 (monitoring AI (14a)), the information of the external data acquired by all the relevant execution AIs (13a) of the execution unit 13, and the like, and obtains an answer by inputting the prompt to the solution AI (12a). The acquired answer is presented to the user 2 via the dialogue unit 11. The content of the answer presented to the user 2 by the dialogue unit 11 and the text information of the response from the user 2 to the content are each stored as a dialogue log in the short-term storage 16 (short-term objective storage 16a).

Thereafter, when the user 2 instructs the end of the dialogue session, the monitoring unit 14 creates a summary of the entire session from the entire dialogue log of the session stored in the short-term storage 16. For example, a prompt for generating a summary including information such as what kind of request the user 2 had, what kind of work the user 2 performed, and how the evaluation of the user 2 was is created and input to the monitoring AI (14a), thereby obtaining the summary of the session.

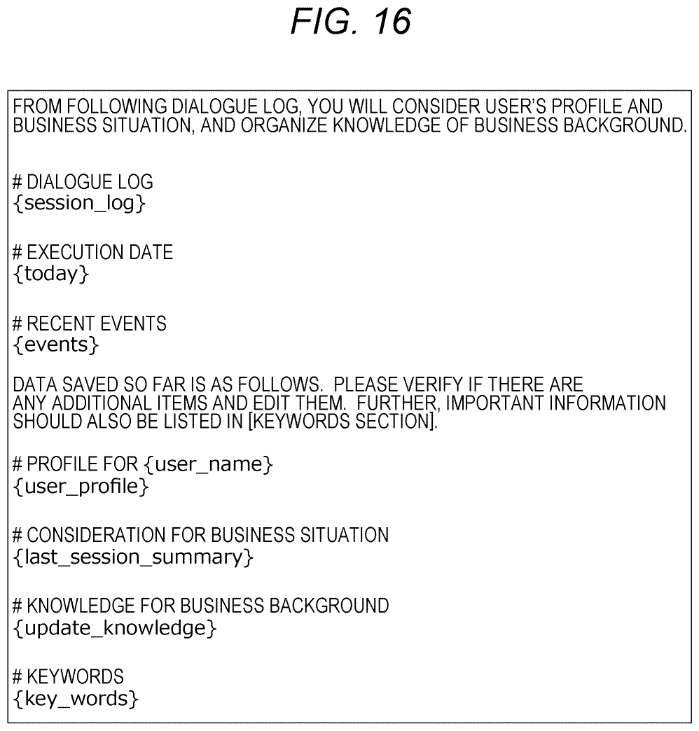

FIG. 16 is a diagram illustrating an outline of an example of a prompt of the monitoring unit 14 that summarizes a dialogue log in one embodiment of the present invention. In the drawing, with reference to the “dialogue log”, knowledge about the profile of the user 2, the business situation, and the business background is acquired from the long-term subjective storage 16b, and correction of a part that needs to be changed is instructed. In addition, it is instructed to extract a keyword for important information. These pieces of extraction information are stored in the long-term subjective storage 16b for subsequent reference. In addition, a dialogue log is separately extracted and summarized as text data to be used next or later from an instruction of the user 2, a created task list, a concise summary sentence of the entire session, and the like, and is stored in the long-term subjective storage 16b.

Returning to FIG. 13, the acquired information such as the summary of the session and the dialogue log is stored in the long-term storage 15 for the later dialogue session as described above, and in a case where it is grasped that there is a change in the information of the user 2, the store information, and the like registered in the setting information 17, these are changed and saved. By a series of processes as described above, the agent system 1 designs, corrects, and executes a task while engaging in an interactive dialogue with the user 2.

As described above, according to the agent system 1 that is one embodiment of the present invention, the whole is divided into a task layer (role sharing by the dialogue unit 11, the solution unit 12, and the execution unit 13) that executes a task and a meta layer (monitoring unit 14) that monitors and stores a business situation, and by combining them, it is possible to realize an agent-type AI that appropriately understands the execution situation of the task and autonomously designs and executes the task.

Although the invention made by the present inventors has been specifically described on the basis of the embodiment, the present invention is not limited to the above-described embodiment, and it goes without saying that various modifications can be made without departing from the gist of the present invention. The above-described embodiment has been described in detail in order to explain the present invention in an easy-to-understand manner, and the present invention is not necessarily limited to one including all the configurations described. Another configuration can be added to, deleted from, and replaced with part of the configuration of the above-described embodiment.

Part or all of the above-described configurations, functions, processing parts, processing units and the like may be implemented by hardware by being designed as an integrated circuit or the like, for example. Alternatively, the above configurations, functions, and the like, may be implemented by software by a processor interpreting and executing a program that implements each function. Information such as programs, tables, and files for implementing each function can be stored in a recording device such as a memory, a hard disk, and an SSD, or in a recording medium such as an IC card, an SD card, and a DVD.

The above drawings illustrate control lines and information lines that are considered necessary for the description and do not necessarily illustrate all the implemented control lines and information lines. In reality, almost all the configurations may be considered mutually connected.

### INDUSTRIAL APPLICABILITY

The present invention can be used for an agent system that implements agent-type AI.

What is claimed is:

1. An agent system that grasps a business instruction from a dialogue with a user and executes a task related to the business instruction, the agent system comprising:
a dialogue unit; a solution unit; an execution unit; and a monitoring unit, each of which is capable of individually using generative AI, wherein
the dialogue unit grasps the business instruction by the dialogue with the user by the generative AI, and stores a content of the dialogue with the user as a dialogue log in a short-term storage unit,
the solution unit creates a task list by decomposing the business instruction grasped by the dialogue unit into tasks by the generative AI, passes an execution instruction of each task to the execution unit, and presents an execution result by the execution unit to the user via the dialogue unit,
the execution unit executes a work by using a corresponding data source by the generative AI corresponding to the task related to the execution instruction passed from the solution unit and passes the execution result to the solution unit, and
the monitoring unit refers to the dialogue log at any time, extracts information regarding a predetermined matter set in advance, grasps a context of the dialogue by the generative AI, predicts a content to be dealt with next, stores the content as a summary in a short-term storage unit, and allows the dialogue unit, the solution unit, and the execution unit to refer to the content at any time.

2. The agent system according to claim 1, wherein
the dialogue unit confirms whether the task list created by the solution unit needs to be corrected by the user through the dialogue with the user, passes a correction content instructed by the user to the solution unit to instruct correction of the task list in a case where correction is required, and instructs the solution unit to execute the task list in a case where correction is not required.

3. The agent system according to claim 1, wherein
when a dialogue between the dialogue unit and the user ends, the monitoring unit extracts predetermined information regarding a business background and/or a business situation of the user by the generative AI on a basis of the dialogue log, stores the extracted information in a long-term storage unit, and allows the dialogue unit and the solution unit to refer to the extracted information at any time.

4. The agent system according to claim 3, wherein
when creating the task list by decomposing the business instruction grasped by the dialogue unit into tasks by the generative AI, the solution unit uses, as input information to the generative AI, information including a summary of the dialogue with the user stored in the short-term storage unit, a past business instruction acquired from the long-term storage unit and similar to the business instruction, and a task design at that time.

5. The agent system according to claim 1, wherein
the execution unit determines whether each task related to the execution instruction passed from the solution unit is executable by corresponding generative AI, and requests the solution unit to correct a target task in a case where the task is inexecutable.

6. The agent system according to claim 5, wherein
in a case where the target task is executable, the execution unit determines whether information necessary for executing the work by using the corresponding data source is insufficient, and in a case where the information is insufficient, the execution unit refers to information in the short-term storage unit and supplements the information.

7. The agent system according to claim 6, wherein
in a case where the information necessary for executing the work using the data source corresponding to the target task is insufficient, the execution unit makes an inquiry to the user via the dialogue unit to supplement the information.
